(19) United States
(12) Patent Application Publication
(10) Pub. No.: US 2024/0160907 A1
(43) Pub. Date: May 16, 2024

(54) QUANTUM RESERVOIR NEURAL NETWORK PROCESSOR

(71) Applicant: UNIVERSITY OF MASSACHUSETTS, Boston, MA (US)

(72) Inventors: Edward Rietman, Boston, MA (US); Hava Siegelmann, Boston, MA (US)

(21) Appl. No.: 18/200,276

(22) Filed: May 22, 2023

Related U.S. Application Data
(60) Provisional application No. 63/345,135, filed on May 24, 2022.

(51) Int. Cl. G06N 3/063; G06N 10/40

(52) U.S. Cl. CPC G06N 3/063; G06N 10/40

(57) ABSTRACT

Various examples are provided related to quantum reservoir neural network processing including machine learning with correlated quantum matter and use of correlated quantum matter as a physical unclonable function (PUF). In one example, a quantum reservoir neural network processor includes a structure including correlated quantum matter; input electrodes that can apply input signals; output electrodes that can provide an output signal generated in response to the input signals and a control signal applied to the structure; and processing circuitry that can receive the output signal and provide the control signal. The processing circuitry can identify an input corresponding to the input signals based upon the output signal. In another example, a PUF includes correlated quantum matter; at least one input electrode disposed on a first side of the correlated quantum matter; and an output electrode disposed on a second side of the correlated quantum matter opposite the first side.

### CROSS REFERENCE TO RELATED APPLICATIONS

This application claims priority to, and the benefit of, co-pending U.S. provisional application entitled “Quantum Reservoir Neural Network Processor” having serial no. 63/345,135, filed May 24, 2022, which is hereby incorporated by reference in its entirety.

### STATEMENT REGARDING FEDERALLY SPONSORED RESEARCH OR DEVELOPMENT

This invention was made with government support provided under grant number W31P4Q-20-1-0002 awarded by DARPA. The U.S. government has certain rights in this invention.

### BACKGROUND

Memristors are often used in building and evaluating hardware neural networks. Memristance can be viewed as the generalized resistance which depends on the internal state of the device. In other words, memristance is charge dependent. A theoretical relationship exists between piezoelectrical materials and memristors.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B illustrate an example of a cube of unpoled lead zirconate titanate (PZT) ceramic with electrodes on each face, in accordance with various embodiments of the present disclosure.

FIGS. 2A and 2B illustrate an example of the PZT cube of FIG. 1A coupled to processing circuitry, in accordance with various embodiments of the present disclosure.

FIG. 3 schematically illustrates an example of a reservoir computer network, in accordance with various embodiments of the present disclosure.

FIG. 4 illustrates an example of a Hilbert curve used to encode an image in a linear sequence, in accordance with various embodiments of the present disclosure.

FIGS. 5A and 5B illustrate examples of I/O mapping of image data and control bitstreams onto the PZT cube of FIG. 1A, in accordance with various embodiments of the present disclosure.

FIG. 6 illustrates an example of output signals per control signal fed into a logistic regression, in accordance with various embodiments of the present disclosure.

FIG. 7 illustrates an example of input digital class and output digital class, in accordance with various embodiments of the present disclosure.

FIG. 8 illustrates an example of testing results, in accordance with various embodiments of the present disclosure.

FIGS. 9A and 9B illustrate an example of dynamics of the I/O behavior of the PZT cube, in accordance with various embodiments of the present disclosure.

FIG. 10 illustrates an example of PZT crystal structures, in accordance with various embodiments of the present disclosure.

FIG. 11 illustrates an example of self-resonance of a PZT cube, in accordance with various embodiments of the present disclosure.

FIGS. 12A-12C illustrates examples of distortions in PZT crystals, in accordance with various embodiments of the present disclosure.

FIG. 13 illustrates an example of test structure comprising piezoelectric material utilized as a physical unclonable function (PUF), in accordance with various embodiments of the present disclosure.

FIGS. 14A-14E illustrate examples of sample responses of test structures comprising poled PZT materials, in accordance with various embodiments of the present disclosure.

FIG. 15 illustrates examples of sample responses of a test structure comprising unpoled PZT material, in accordance with various embodiments of the present disclosure.

### DETAILED DESCRIPTION

Disclosed herein are various examples related to quantum reservoir neural network processing including machine learning with correlated quantum matter and use of correlated quantum matter as a physical unclonable function (PUF). The use of poled piezoelectric materials, such as lead zirconate titanate (PZT), is described for use in a secure computing device known as a PUF. And the use of unpoled piezoelectric materials, such as lead zirconate titanate (PZT), is described for use in a quantum reservoir neural network. Reference will now be made in detail to the description of the embodiments as illustrated in the drawings, wherein like reference numbers indicate like parts throughout the several views.

Correlated quantum matter is a new realization of, or a new understanding of, something that has had technological uses for some decades. This new understanding is the result of research investigating quantum information processing and quantum computing. The correlated quantum matter explored here for various applications includes piezoelectric materials such as, e.g., PZT or other piezoelectric ceramics (e.g., aluminum nitride, barium titanate, bismuth titanate, lead scandium tantalite, the perovskites lithium tantalite and sodium bismuth titanate), polyvinylidene fluoride (PVDF), polyvinyl alcohol (PVA), PVDF blended with polymethylmethacrylate, PVA bended with polymethylmethacrylate, apatite, gallium phosphate, lanthanum gallium silicate, potassium sodium tartrate, quartz and/or rutilated quartz. These correlated quantum materials may be considered as programmable matter. This in-materio computation suggests a paradigm shift from algorithms to interaction.

A new kind of computation based on interactions has been suggested. When the notion of what is computable is expanded to include interactions of elements, as in the case of programmable matter, the Church-Turing thesis becomes invalid, because of effectively moving out of the domain of logical operations. Interestingly, process algebras and π-calculus may be applicable to preparing a compiler for programmable matter. In summary, to avoid the trap of demonstrating the programmable matter by developing logic gates, rather, targeting challenging new applications, beyond the Church-Turing thesis, and exploiting this computing paradigm can provide a new form of non-classical hypercomputing. In this disclosure, a simple learning machine example MNIST digit recognition will be demonstrated.

Memristance View of Piezoelectricity. Memristors have been proposed and demonstrated. Initially, successful materials were typically doped (or poled) TiO₂. Later experiments were carried out with ZnO or silver sulfide nanowires as atomic switches. Except for the Ag₂S case, which is a fast ion conductor, in all other cases these materials are also piezoelectric. In this disclosure, use of a bulk matrix of piezoelectric material, such as PZT or PVDF, as a computational substrate was suggested. Here, a novel way to exploit the physics of piezoelectric materials for computation is proposed. The theoretical connection between piezoelectricity and memristance is considered.

Resistance under Stress. The resistance of a block of dielectric, or any solid matter, is given by

$$\\ R = ρ \frac{l}{A} ,$$

where R is the resistance in ohms, ρ is resistance in ohm·m, l and A are the length and area, respectively, of the block. And those dimensions are in meters. A is the cross-section and given by A=zw. Taking the logarithm of the resistance relation and differentiating gives:

$$\\ \frac{dR}{R} = \frac{d ρ}{ρ} + \frac{dl}{l} - \frac{dA}{A} .$$

So writing, dA/dw=z→dA/A=dw/w. Further, the elastic axial strain in the piezomaterial and the transverse strain are respectively defined as:

$$\\ {ε}_{a} = \frac{dl}{l} and {ε}_{t} = \frac{dw}{w} .$$

The Poisson ratio is defined as the ratio of axial to transverse strains:

$$\\ μ = - \frac{dw / w}{dl / l} .$$

If it is assumed that the resistance of the material does not change with strain then

$$\\ d ρ / ρ = 0.$$

Combining equations gives:

$$\\ \frac{dR}{R} = \frac{dl}{l} ( 1 + μ ) .$$

This equation represents the change in the general resistance due to any induced mechanical stress. And of course, in a poled piezoelectric medium, the induced stress could be caused by an external electric field.

Memristance. Turning now to look at memristance, the charge to flux ratio gives the magnetic flux:

$$\\ \frac{d φ}{dq} = M ,$$

which can be rewritten as a time derivative:

$$\\ \frac{d φ}{dq} = \frac{d φ / dt}{dq / dt} = \frac{v}{i} = \hat{R} = M ,$$

where v and i are voltage and current. \hat{R} is the average resistance, and depends on the internal state of the device. Now taking the partial derivative of the flux ratio:

∂φ=q∂M+M∂q.

If the total charge in the system is constant, and then taking the time derivative:

$$\\ \frac{d φ}{dt} = q \frac{dM}{dt} = v ,$$

and because memristance is an average resistance M=ρl/A, it can be written:

$$\\ v = q \frac{Mdl}{ldt} ( 1 + μ ) .$$

Rearranging gives:

$$\\ \frac{v}{dl} = \frac{q ρ ( 1 + μ )}{Adt} = ρ ( \frac{q}{A} ) \frac{( 1 + μ )}{dt} .$$

This equation indicates that the time dynamical stress associated with the memristance is an analogue of piezoelectricity.

### Methods

Piezoelectric materials are typically poled. In the case of PZT, poling is done at a temperature above the Curie point, at which point the crystal lattice can be distorted by slight movement of the titanate (Ti) and zirconate (Zr) atoms. The material is subjected to a DC voltage of about 2000 V above the Curie point (553 K for PZT) for a period of time; then it is allowed to cool in the furnace before removing the DC voltage. This poling operation freezes into place the lattice distortions so the crystallites are essentially aligned. This results in resonances at specific frequencies and these resonances interfere with program and control signals during attempts to use the PZT as a reservoir architecture. Therefore, unpoled PZT is used for the experiments.

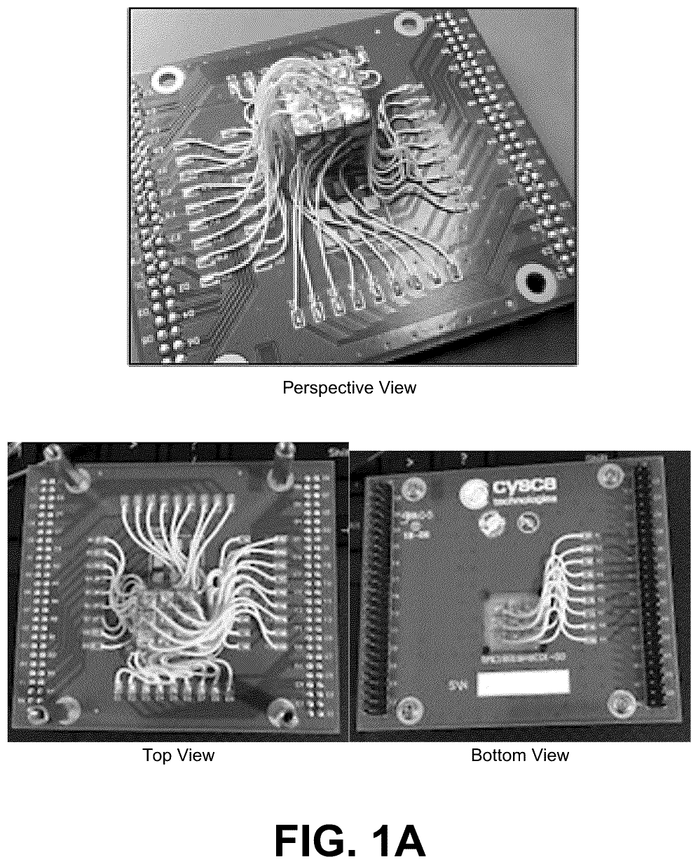

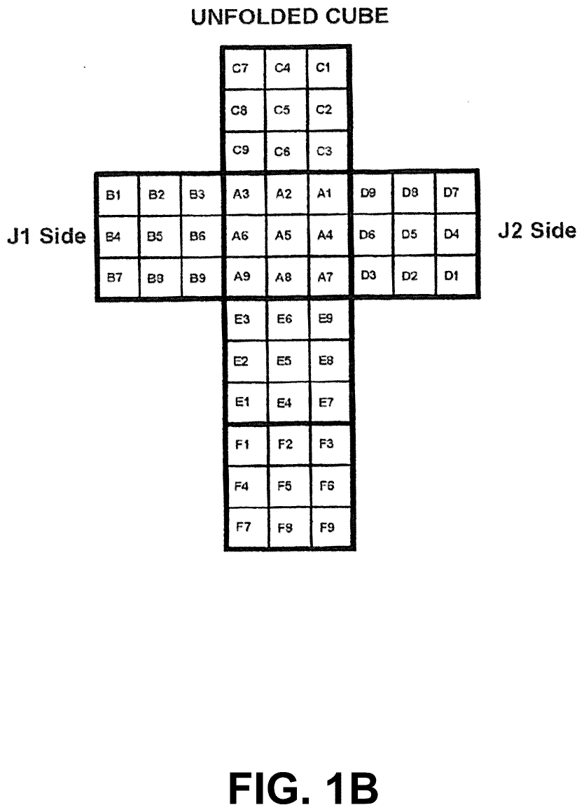

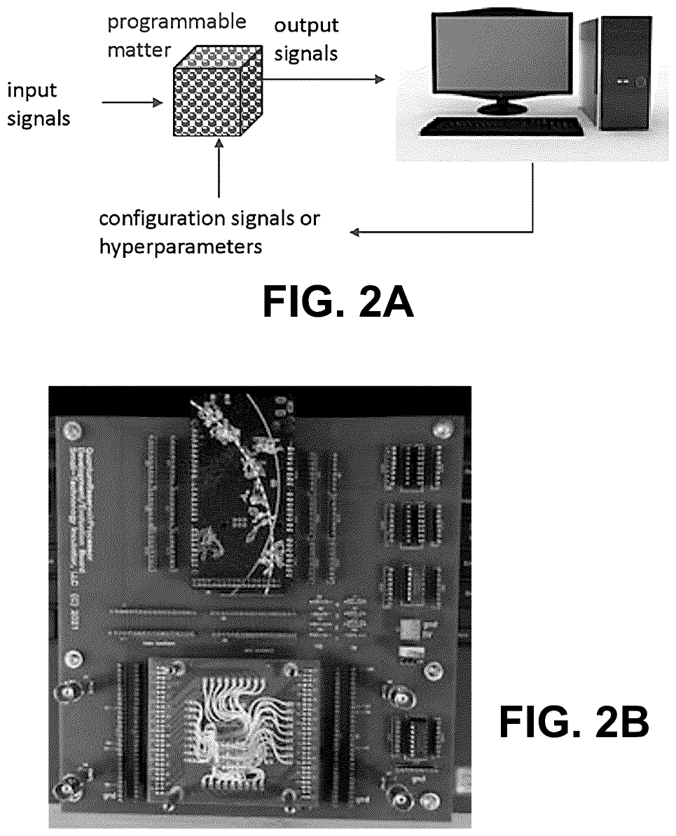

The PZT cube was made from unpoled type 880 material from American Piezo®, Inc. It measured 1.5 cm on an edge and all faces were silvered as received. Other cube sizes may be utilized. Other structure geometries can also be used (e.g., rectangular block, pentagonal prism, hexagonal prism, etc.). The number of electrode pads can be the same or different on the surfaces or faces of the structure. A Dermel® tool was used to etch electrode pads (e.g., nine little squares) on each face of the PZT, and the PZT cube was further etched along the edges to remove contacts between faces. FIG. 1A includes images of a 1.5-cm cube of unpoled PZT ceramic fabricated with nine electrodes per face mounted on a break-out board. While this implementation utilized nine electrode pads per face, other combinations of electrode pads can also be used. FIG. 1B is a schematically illustrates the electrodes on the unfolded cube. As seen in FIG. 1A, wires were silver soldered to the electrode pads. The entire cube was then coated with 5-minute epoxy and attached to the break-out board. FIG. 2A is a schematic diagram illustrating a configuration for programming and/or computation using the PZT cube. For example, input signals can be applied to the PZT cube to produce output signals that can be supplied to processing circuitry (e.g., a microprocessor or computing device) for interpretation. The processing circuitry can provide configuration signals or hyperparameters to the PZT cube. FIG. 2B is an image showing the cube of PZT material coupled to processing circuitry.

### Reservoir Neural Network Architecture

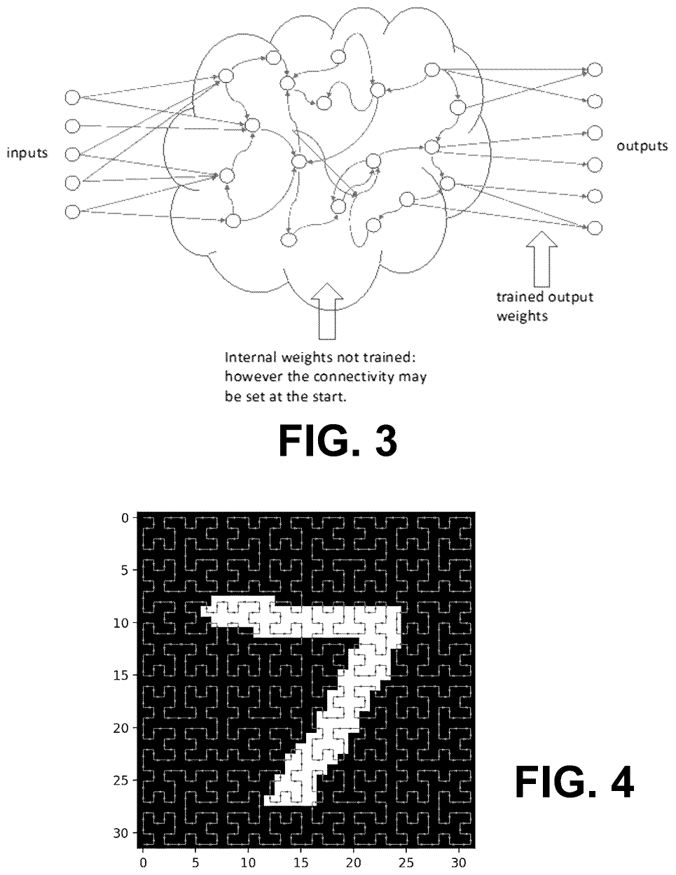

A reservoir network is a generalization of recurrent networks. FIG. 3 schematically illustrates an example of a reservoir computer network. The internal weights are not trained, only the output weights are trained. As shown in FIG. 3, and implied by FIG. 2A, the reservoir network includes inputs that are sent to the reservoir then outputs are read and analyzed by processing circuitry (e.g., an external computer) that trains the output weights using an algorithm such as, e.g., multilinear regression or gradient descent. Once the training is done, one can feed in inputs, read outputs and lookup the results. In the case of the PZT cube (FIG. 1A), the configuration signals can set up the “internal weights” (FIG. 3) which are streamed in simultaneously with the input signal.

### Machine Learning Example: MNIST Digit Recognition

In order to assess the ability of the cube to support machine learning the collection of MNIST handwritten digits was downloaded and transformed such that every instance was represented as a 32×32 binary image. In total, 10,000 cases were used (7500 for training and 2500 for testing).

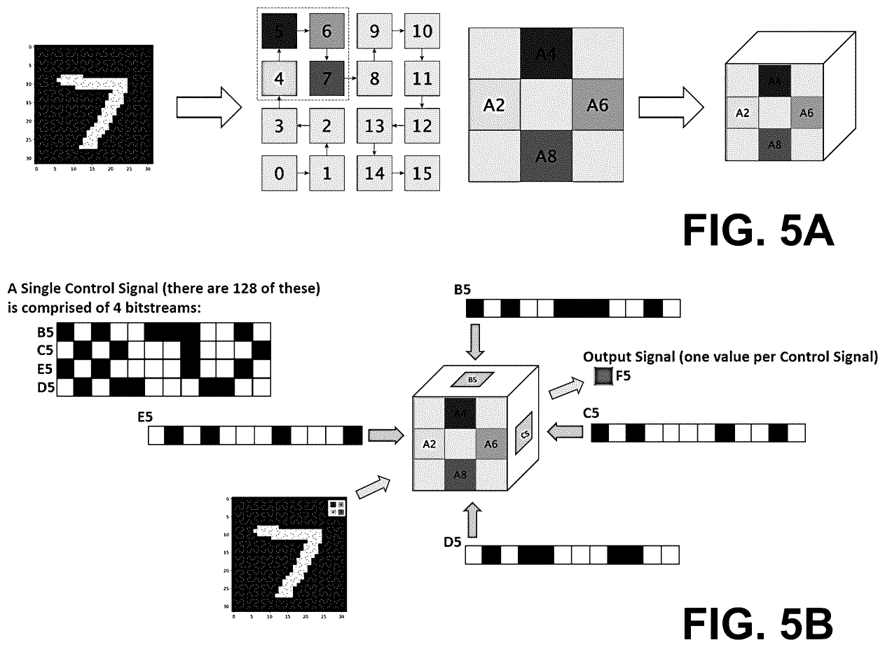

As the fabricated cube provides a limited number of interface electrode pads, it is not possible to feed the image in parallel, so a sequential scheme was utilized. A simple linear scan of the image would likely hurt the locality of the input since consecutive pixels may be as far away from each other as the full width of the overall image (when wrapping around the image). A 2D Hilbert scan was applied instead since it is known to better preserve locality when transforming 2D images into a linear format. The mapping from 2D to 1D using the Hilbert scan is shown in FIG. 4 (the arrows illustrate the scan sequence). FIG. 5A illustrates an example of the input/output (I/O) mapping of the image date onto the cube. In this case, each set of 4 image bits was applied to four electrode pads on the “A” face of the cube (e.g., pads A2, A4, A6, A8 as shown in FIG. 4).

The original 28×28 pixel-images were expanded to 32×32 pixel-images to scan the images with the Hilbert curve. Scanning the 1024 pixels was done in 256 steps. At each of these steps, along with the image data, four bits of “control signals” were applied to the center pad on the “B”, “C”, “D”, and “E” faces of the cube. FIG. 5B illustrate the data being processed by injection the control bitstreams, which constitute the cube's program. In other words, a total of 1024 bits of control signal are used (4 bits of control signal for each of the 256 steps). Throughout the acquisition, the voltage on the center pad of the output face (face “F”) is read and summed to yield a single scalar value. The entire procedure can be repeated 128 times to produce the final output which comprises128 cumulative voltage measurements.

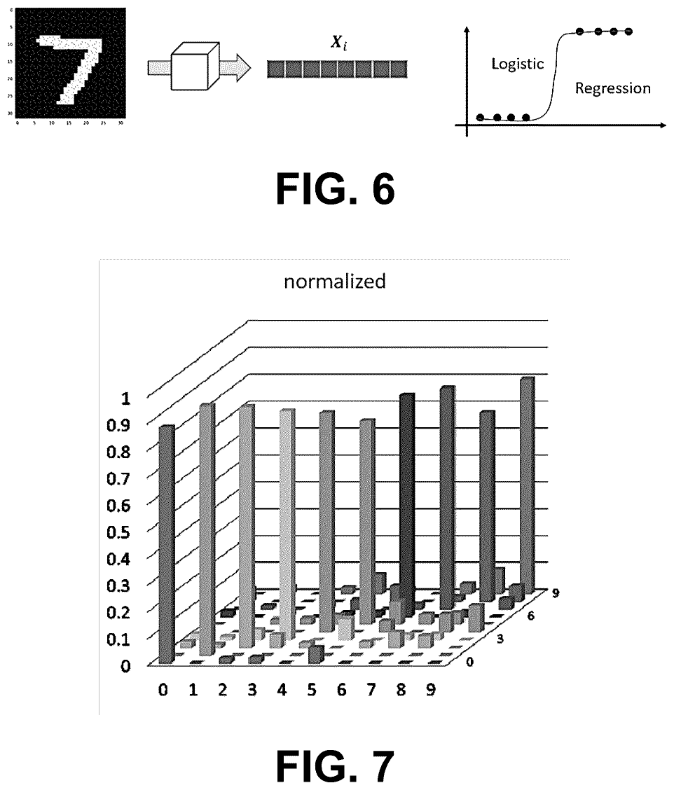

The resulting output for all test images were analyzed by multi-class logistic regression, also known as the softmax. As shown in FIG. 6, the output signals per control signal are fed into the logistic regression. The softmax score sₖ(x) for a particular class k, where k=(0, 1, . . . , 9) includes the digit classes, is given by:

sₖ(x)=(θ^{(k)})^{T}·x,

where x is a particular instance and θ^{(k)} is a parameter vector. After computing the score for each class, the softmax function can be run to get the probability:

$$\\ {\hat{p}}_{k} = {σ ( s ( x ) )}_{k} = \frac{exp ( {s}_{k} ( x ) )}{{\sum }_{j = 1}^{K} exp ( {s}_{j} ( x ) )} .$$

Sofmax predicts the highest estimated probability for each class as illustrated in FIG. 6.

### Results and Discussion

Having developed the parameter matrix θ, the cube of quantum material can be tested. FIG. 7 illustrates an example of the x-axis and y-axis are the input digital class and output digital class, respectively. The z-axis is the averaged normalized response for 2500 test digits. As shown in FIG. 7, the total results are about 80% correct classification for all digits. Putting this in perspective, this is essentially a lump of unpoled PZT ceramic that is being exploited for machine learning.

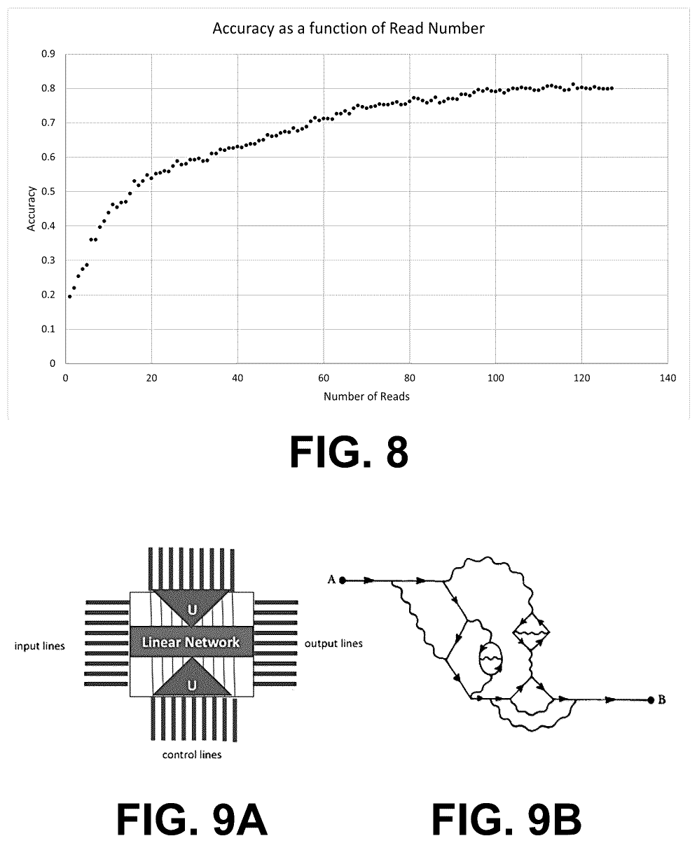

After training, which involved the logistic regression algorithm to develop the parameter matrix θ, the four bit strings from the Hilbert scan and the four control strings were then submitted to the cube for each digit to test its response. Since the images are 1024 bits in length, the images by scanning the Hilbert curve four input pads are being entered at once, thus four 256-bit length strings were entered it into the cube. Similarly, with the control strings of 256-bit length. As this operation was repeated, it was observed that the accuracy increases and plateaus at about 0.8. FIG. 8 shows the testing results, where increasing the number of reads (where each read of the input is run along with a different set of control signals) appears to increase prediction accuracy until about one hundred reads, beyond which the performance appears to stabilize.

To develop the possible dynamics inside the PZT cube, consider FIGS. 9A and 9B. FIG. 9A is a schematic illustrating an example of a system to describe the dynamics (of the I/O behavior) taking place in a PZT cube. Assume the connections on the left are input and the connections in the right are outputs. The inputs will combine in a linear way and can be monitored on the outputs. However, when control signals are added to any of the control lines, they can act as a “scattering matrix” (U) and linearly combine with the inputs. The resulting output has thus been changed by the scattering matrix, and is no longer a linear relation of the inputs, but rather it is now a linear superposition of the inputs and the control signals. This is the same type of dynamic operation of a photonic quantum architecture.

The schematic of FIG. 9B shows a “conjectured” Feynman diagram for the dynamics inside the PZT cube. In this case, it represents a complex interaction of electrons and phonons (electron phonon scattering suggesting the type of complex dynamics taking place inside the cube at the nano-scale). It would be very difficult to do a detailed modeling of the actual dynamics. That being said, some intuition of the internal dynamics can be developed. First, examine the crystal structure and the effects of applying an electric field to the crystal.

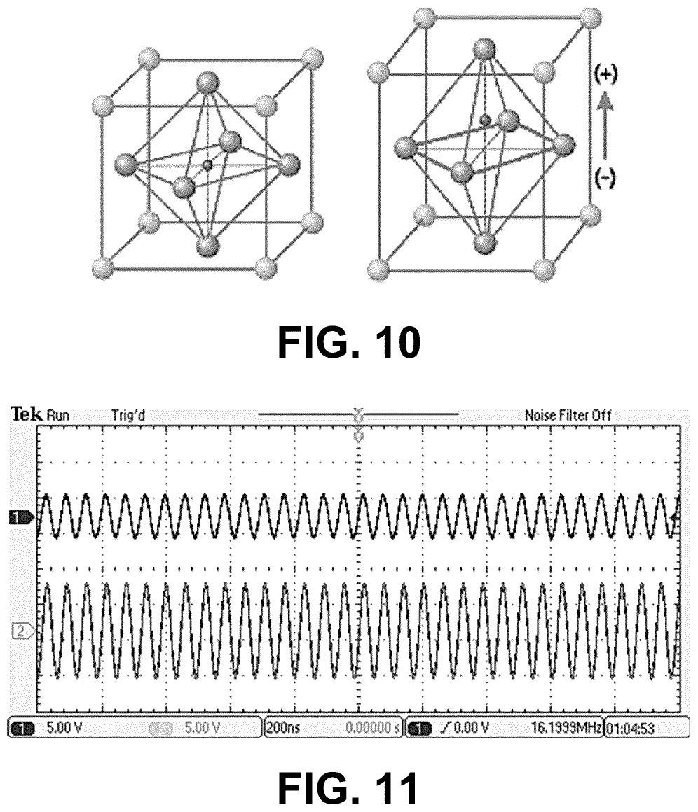

The crystal structure of lead zirconate titanate is shown in FIG. 10. The spheres at the outer corners are lead (Pb), the spheres at the inner corners are oxygen, and the small sphere in the center is titanium (Ti) or zirconium (Zr). The structure on the left of FIG. 10 is a “relaxed” crystal of PZT. It is perovskite lattice. The lead atoms are on the vertices of a cubic lattice, the oxygen atoms are on the face-centers of the cubic lattice, and zirconium or titanium are in the body-center of the cubic lattice. With an overall stichometry of Pb[ZrₓTiₓ₋₁]O₃ with (0≤x≤1). The structure on the right of FIG. 10 is a distorted crystal lattice. It is elongated by about 0.1% in the vertical direction when an electric field is applied. These distortions can be very accurately measured in X-ray diffraction.

Since the ceramic material being used comprises micron-scale crystallites (i.e., single crystals), these crystallites are oriented at random. When, an electric field is applied to the bulk unpoled ceramic, the crystallites will align in the field. Since the PZT ceramic is essentially a dielectric material and the PZT ceramic cubes with electrodes attached are essentially a ceramic capacitor, then it will allow high frequency to pass through, but as the frequency drops from, say, 10 s of MHz to 10 s of kHz the impedance of “device” will increase. While an AC signal is propagating through the PZT cube it will naturally form polarized regions of compression of the crystallites and regions of rarefaction, analogous to a sound wave in a fluid medium. These distortions result in constructive and destructive interference and give rise to an overall linear superposition of the input and control signals at the output, thus enabling programming of the PZT cube as a neural network. Also, by analogy with acoustic waves, it is possible to observe a standing wave at 16.2 MHz (shape and size of PZT device dependent), which acts like a pinning frequency, to pin the dipoles into place. At this frequency, a self-resonance can be obtained as observed in FIG. 11. The upper trace is the input signal and the lower trace is the resonance signal, with both set on a 5V scale. The output resonance signal amplitude is 2.6× as large as the input amplitude (13 Vpp vs 5 Vpp). This is likely due to constructive interference between the input and the output and is shown in FIG. 11. Similar results were obtained on similarly constructed PZT cubes.

It was also found that the output is a non-linear superposition of the input and control signals if the PZT is not poled. This allows the device to be exploited as a reproducible (from PZT cube to PZT cube) computation, and obtain similar accuracy with the same parameter matrix θ. Training and testing was carried out on one PZT cube and testing was carried out on two other devices which obtained comparable results (+/−1%). However, it was also found that poled PZT ceramic did not give reproducible accuracy. In effect, each was found to be unique when measuring the impedance spectrum, which suggests that the poled device can act as a physical unclonable function (i.e., a type of security device). This further suggests that poled cubes of PZT may be used as a secure computing component in a larger system.

Some possible parallels with quantum computing should be pointed out. First, it is known that quantum mechanics is not exactly in line with the laws of probability. A single observation tells nothing, (see FIG. 8) and one must read the response dozens of times. In classical systems, a signal s(t) that has a finite mean \hat{t} and standard deviation Δt; and the signal mean \hat{ω} with standard deviation Δω, will typically obey the uncertainty principle ΔtΔω≥½. This is not the case with quantum computers with potentially entangled states. In the experimental system, superposition has been observed, a necessary condition for entangled states, but it is not possible to say, at this time, if the error shown in FIG. 8 is due to entanglement or “classical” noise.

In classical probability theory, a joint distribution μ ∈ P^{A×B} is uncorrelated if it can be expressed as a tensor product μ_{A}⊗μ_{B}. The majority of joint distributions do not have this form so, they are correlated. An uncorrelated distribution is the tensor product of its marginals, and other distributions cannot be constructed from the marginals. In quantum computing tensors products have a special property among the coefficients. For example, in the following tensor product:

r|a₀ [symbol] |b₀ [symbol] +s|a₀ [symbol] |b₁ [symbol] +t|a₁ [symbol] |b₀ [symbol] +u|a₁ [symbol] |b₁ [symbol] ,

here r²+s²+t²+u²=1, so effectively, r, s, t, u become probability amplitudes. When, ru=st the qbits are not entangled; however, when ru≠st, represents entanglement.

Attention can also be drawn to FIG. 7 with analogies to Boson sampling. In Boson sampling one makes repeated measurements (also see FIG. 8) on all output classes at the same time. The signals are recorded, processed, and the probabilities are typically presented in a bar chart similar to FIG. 7. This method is not Boson sampling; however, given more inputs, control pads, and outputs one could explore the possibility of Boson sampling.

In conclusion, a similarity between memristors and piezoelectric materials has been demonstrated. A way to exploit PZT for computation and the use of it for physical unclonable function applications has also been shown. Lastly, the unpoled PZT ceramic, may be an example of correlated quantum matter that may be used as an example of a quantum learning machine. Incidentally, a controlled-NOT gate (CNOT)—a quantum gate—has also been demonstrated.

### Correlated Quantum Matter as a PUF

The correlated quantum matter that has been explored for physical unclonable function (PUF) applications includes piezoelectric materials. For use as a PUF, the piezoelectric material is poled. Other metal oxides, ferroelectrics, provskites, charge density wave (CDW) materials, or other material that can exhibit a “pinning frequency” may also be used. The specific example of correlated quantum matter examined here is lead zirconate titanate (PZT), though many materials with mobile dipoles (e.g., polymers), mobile electrons (e.g., CDW), or “flexible” crystal lattice may be used. However, poling or pinning the lattice or dipoles into place allows the PZT to be used as a secure computational medium.

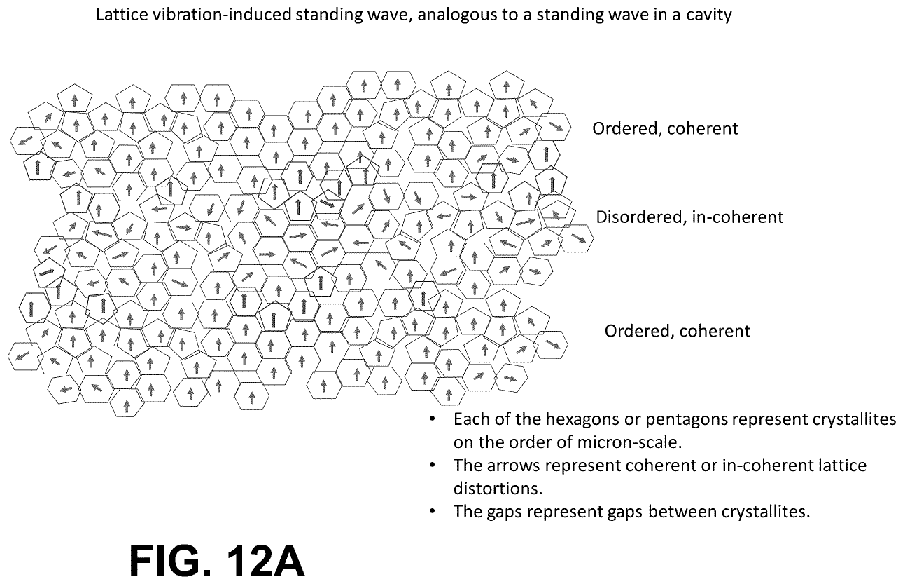

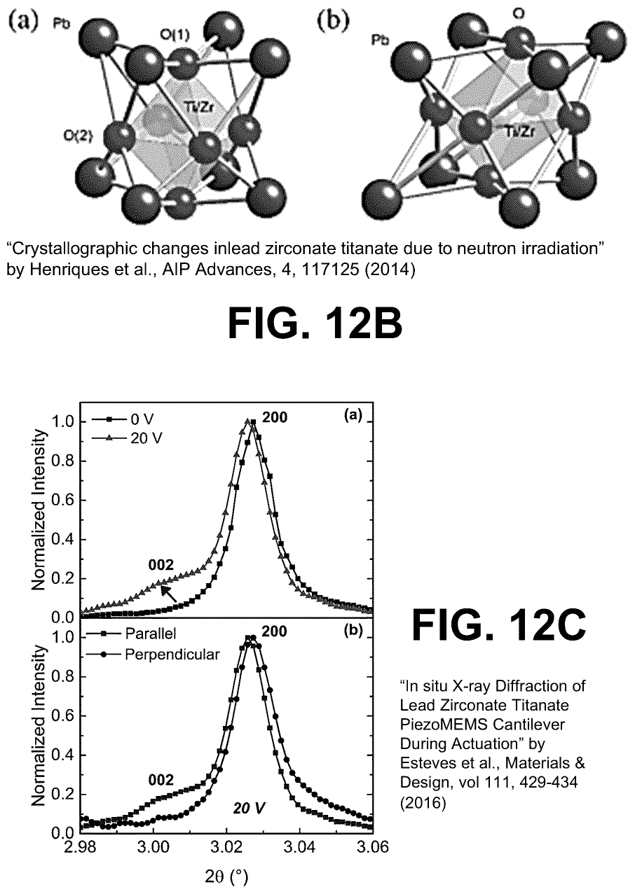

A sound wave traveling through a medium like a fluid (e.g., water or air) will result in regions of compression and regions of rarefication. This is analogous to the application of an electric field potential to a sample of freshly prepared piezoelectric material above the Curie temperature and then letting it cool down in the furnace to establish “pinned” lattice distortions. FIG. 12A illustrates an example of the concept of pinned lattice distortions. FIG. 12B shows the actual crystal distortions for PZT (“Crystallographic changes inlead zirconate titanate due to neutron irradiation” by Henriques et al., AIP Advances, 4, 117125, 2014) and FIG. 12C shows the same distortions as measured by X-ray powder diffraction in the presence of an electric field (“In situ X-ray Diffraction of Lead Zirconate Titanate PiezoMEMS Cantilever During Actuation” by Esteves et al., Materials & Design, vol 111, 429-434, 2016).

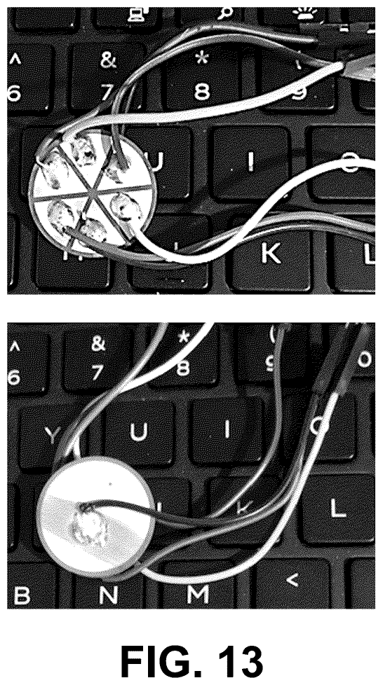

FIG. 13 shows an example of a test structure. It comprises a piece of PZT ceramic, type 880 manufactured by American Piezo. The piece is 2.54 cm in diameter and 0.2 cm thick. The piece was poled and has six electrodes on one side and one electrode on the other side as shown in FIG. 13. There is nothing special about this shape or electrode pattern. Many possibilities exist. A unique “signature” can be obtained for each PZT sample by scanning the frequency and measuring the impedance. A four probe, HP4192A impedance analyzer was used for the measurements, but other types of instruments may be used for acquiring the “signature.”

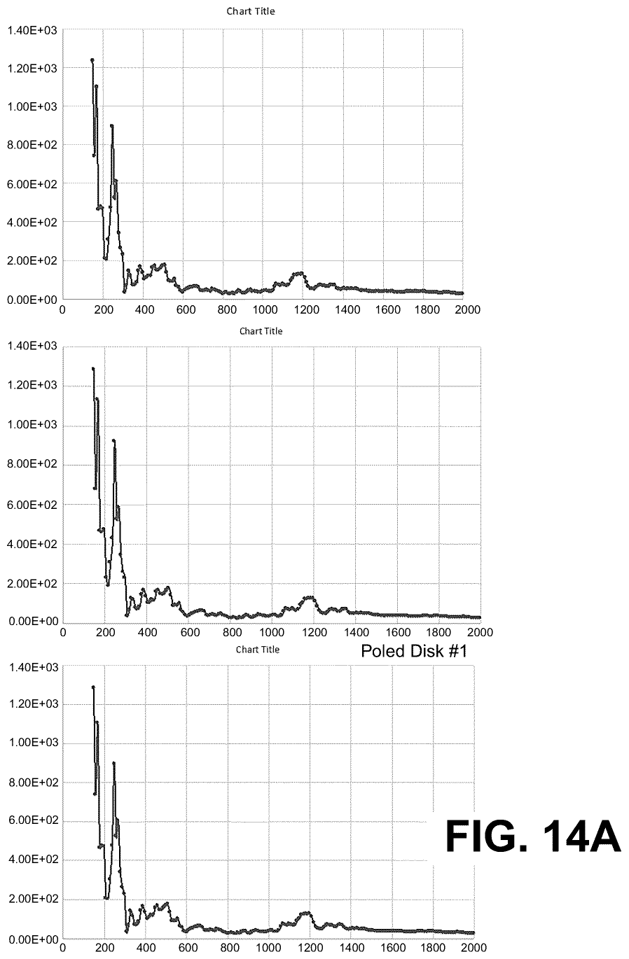

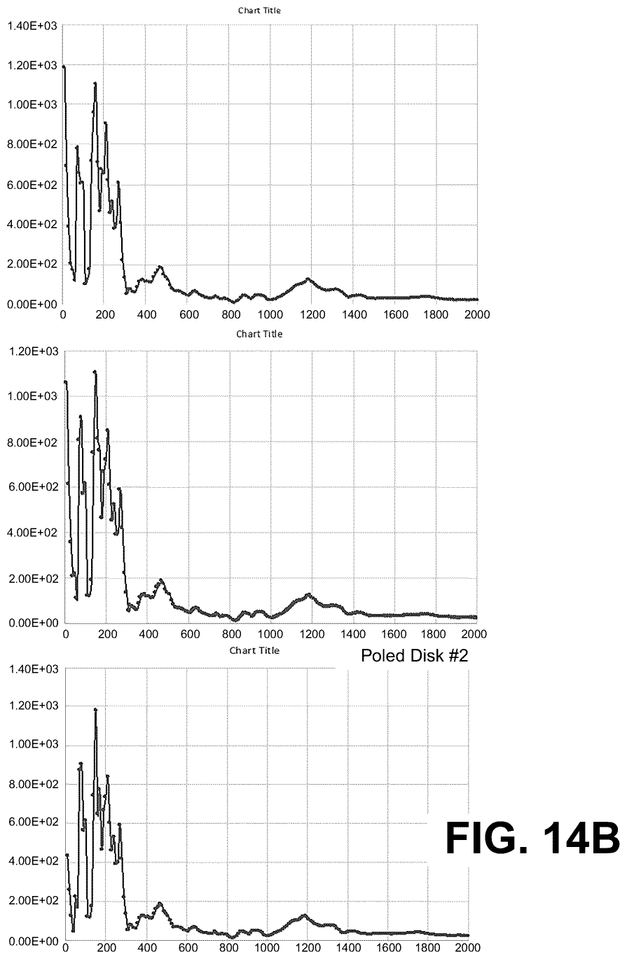

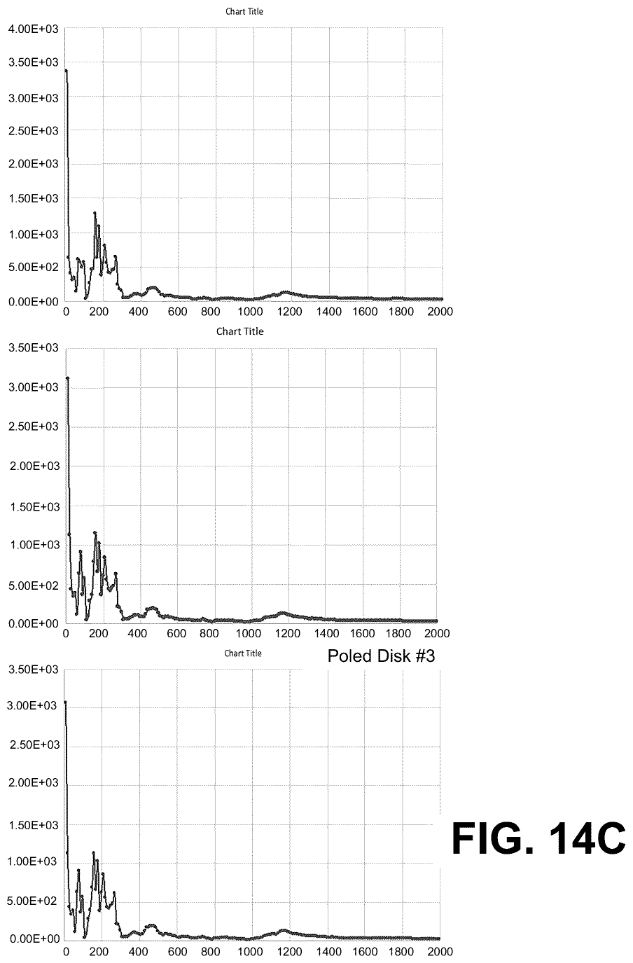

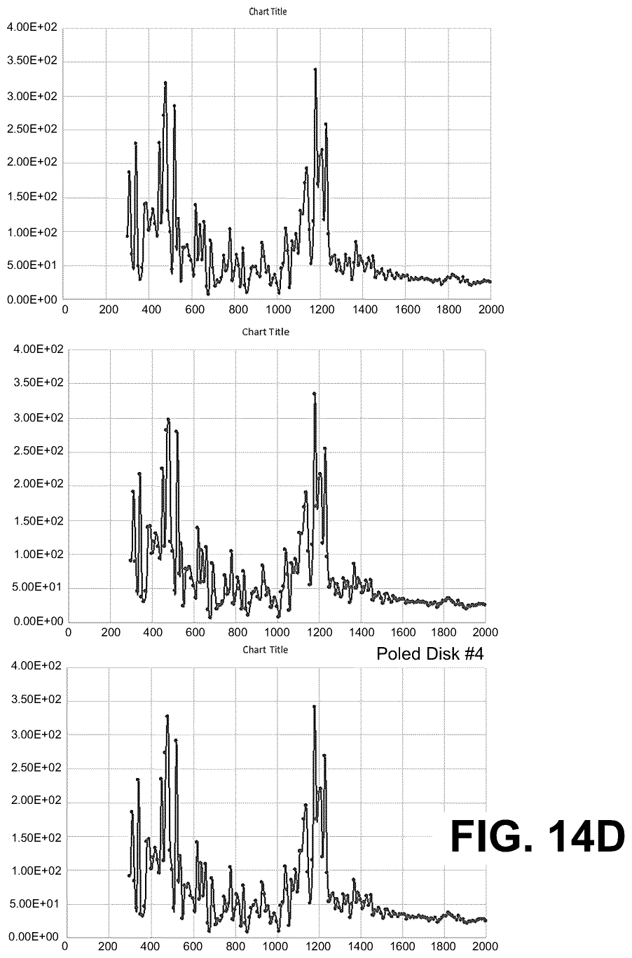

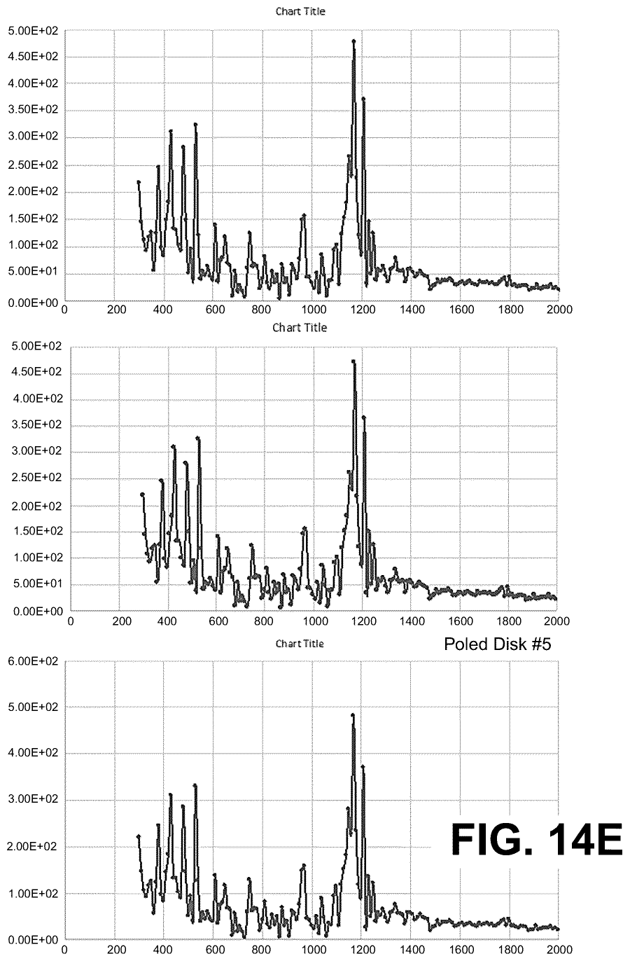

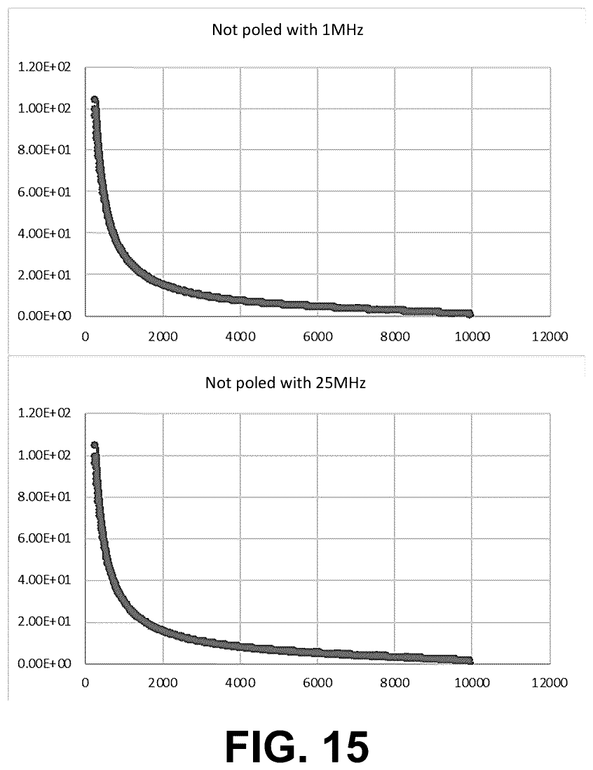

FIGS. 14A-14E each show a sample run in triplicates. The X-axis is the frequency in units of kHz and the Y-axis is the resulting impedance in units of ohms. FIG. 15 shows a similar piece of PZT with same dimensions and electrode pattern as those in the other figures. In this case, however, the sample was not poled. As can be seen in FIG. 15, even with application of an external signal (1 MHz in one example and 25 MHz in another sample) there are no resonances observed.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A quantum reservoir neural network processor, comprising:
a structure comprising correlated quantum matter;
a plurality of input electrodes disposed on a first surface of the structure, the plurality of input electrodes configured to apply input signals to the structure;
a plurality output electrodes disposed on a second surface of the structure, the output electrodes configured to provide an output signal generated in response to the input signals and one or more control signal applied to the structure;
at least one control electrode disposed on a third surface of the structure, the third surface located between the first and second surfaces; and
processing circuitry configured to receive the output signal from the output electrodes and provide the one or more control signal, wherein the processing circuitry identifies an input corresponding to the input signals based upon the output signal produced in response to the input signals and the one or more control signal.

2. The quantum reservoir neural network processor of claim 1, wherein the at least one control electrode comprises a plurality of control electrodes.

3. The quantum reservoir neural network processor of claim 2, wherein each of the plurality of control electrodes is disposed on a different surface of the structure, each of the different surfaces located between the first and second surfaces.

4. The quantum reservoir neural network processor of claim 1, wherein the structure is a cube of unpoled piezoelectric material.

5. The quantum reservoir neural network processor of claim 4, wherein the unpoled piezoelectric material is unpoled lead zirconate titanate (PZT).

6. The quantum reservoir neural network processor of claim 4, wherein the at least one control electrode comprises control electrodes disposed on two or more surfaces located between the first and second surfaces.

7. The quantum reservoir neural network processor of claim 6, wherein a control electrode is disposed on all four surfaces located between the first and second surfaces.

8. The quantum reservoir neural network processor of claim 1, wherein the input is identified by the processing circuitry using logistic regression.

9. The quantum reservoir neural network processor of claim 1, wherein each of the one or more control signal comprises a control bitstream.

10. A physical unclonable function (PUF), comprising:
correlated quantum matter;
at least one input electrode disposed on a first side of the correlated quantum matter; and
an output electrode disposed on a second side of the correlated quantum matter opposite the first side.

11. The PUF of claim 10, wherein the correlated quantum matter comprises poled piezoelectric material.

12. The PUF of claim 11, wherein the poled piezoelectric material is poled lead zirconate titanate (PZT).

13. The PUF of claim 12, wherein the poled piezoelectric material is a PZT ceramic.

14. The PUF of claim 10, wherein the output electrode is coupled to processing circuitry configured to generate a unique frequency signature in response to an input signal applied to the at least one input electrode.

15. The PUF of claim 10, comprising a plurality of input electrodes disposed on the first side of the correlated quantum matter.

16. The PUF of claim 10, wherein the correlated quantum matter comprises a geometric shape including the first and second sides.

17. The PUF of claim 16, wherein the geometric shape is a circular disc.

18. The PUF of claim 16, wherein the geometric shape comprises a plurality of surfaces extending between the first and second sides.
